(19) United States
(12) Patent Application Publication
(10) Pub. No.: US 2026/0292230 A1
(43) Pub. Date: Sep. 24, 2026

(54) SUBSTREAM MULTIPLEXING APPROACH FOR LEARNING-BASED POINT CLOUD COMPRESSION

(71) Applicant: InterDigital VC Holdings, Inc., Wilmington, DE (US)

(72) Inventors: Jiahao Pang, Plainsboro, NJ (US); Gurdeep Bhullar, Montreal (CA); Muhammad Asad Lodhi, Highland Park, NJ (US); Junghyun Ahn, New York, NY (US); Dong Tian, Boxborough, MA (US)

(21) Appl. No.: 19/088,421

(22) Filed: Mar. 24, 2025

(51) Int. Cl. H04N 19/48; H04N 19/169; H04N 19/184; H04N 19/70

(52) U.S. Cl. CPC H04N 19/48; H04N 19/184; H04N 19/1883; H04N 19/70

(57) ABSTRACT

Some embodiments of a method may include: obtaining number of substreams, wherein the number of substreams indicates quantity of one or more substreams; obtaining a bit precision, wherein the bit precision indicates quantity of bits used to represent each of one or more lengths corresponding respectively to the one or more substreams; obtaining the one or more lengths according to the obtained bit precision; and parsing the one or more substreams from an input bitstream, according to the one or more lengths corresponding respectively to the one or more substreams.

### INCORPORATION BY REFERENCE

The present application incorporates by reference in their entirety the following applications: U.S. Non-Provisional patent application Ser. No. ______, entitled “PROTECTION MASK CODING FOR REPRODUCIBLE LEARNING-BASED COMPRESSION” and filed Mar. 24, 2025 (“xxx application”); U.S. Non-Provisional patent application Ser. No. 18/637,370, entitled “REPRODUCIBLE LEARNING-BASED POINT CLOUD CODING” and filed Apr. 16, 2024 (“370 application”).

### BACKGROUND

The present application is related to point clouds.

### SUMMARY

A first example method in accordance with some embodiments may include: obtaining number of substreams, wherein the number of substreams indicates quantity of one or more substreams; obtaining a bit precision, wherein the bit precision indicates quantity of bits used to represent each of one or more lengths corresponding respectively to the one or more substreams; obtaining the one or more lengths according to the obtained bit precision; and parsing the one or more substreams from an input bitstream, according to the one or more lengths corresponding respectively to the one or more substreams.

Some embodiments of the first example method may further include obtaining the input bitstream.

For some embodiments of the first example method, the bit precision is large enough to hold a maximum value of the one or more lengths.

For some embodiments of the first example method, the bit precision is a power of 2 corresponding to a data type.

For some embodiments of the first example method, the bit precision is selected from the group consisting of 8, 16, 32, and 64.

Some embodiments of the first example method may further include obtaining a size of sets of substreams, wherein the size of sets of substreams indicates quantity of substreams within the one or more sets of substreams.

For some embodiments of the first example method, the size of sets of substreams indicates at least the number of substreams in a first set of substreams and a second set of substreams.

For some embodiments of the first example method, the bit precision is a first bit precision, and the first example method may further include: obtaining a second bit precision, wherein the second bit precision indicates quantity of bits used to represent each of a second set of lengths corresponding respectively to the second set of substreams; obtaining the second set of lengths according to the obtained second bit precision; and parsing the second set of substreams from the input bitstream, according to the second set of lengths corresponding respectively to the second set of substreams, wherein the first bit precision is different than the second bit precision.

For some embodiments of the first example method, wherein the one or more substreams include three or more sets of substreams, wherein the one or more lengths include three or more sets of lengths, wherein each of the three or more sets of substreams correspond respectively to the three or more sets of lengths, wherein each of the three or more sets of lengths correspond respectively to a bit precision, and wherein each of the respective bit precisions indicates quantity of bits used to represent each of the lengths of the corresponding set of lengths.

Some embodiments of the first example method may further include rendering the one or more substreams on a display device.

A second example method in accordance with some embodiments may include: determining a bit precision, wherein the bit precision indicates quantity of bits used to represent each of one or more lengths corresponding respectively to one or more substreams; writing number of substreams into a multiplexed bitstream, wherein the number of substreams indicates quantity of the one or more substreams; writing the bit precision into the multiplexed bitstream; writing the one or more lengths of the one or more substreams into the multiplexed bitstream, according to the determined bit precision; and writing the one or more substreams into the multiplexed bitstream.

For some embodiments of the second example method, writing the one or more substreams into the multiplexed bitstream writes the one or more substreams sequentially into the multiplexed bitstream.

For some embodiments of the second example method, the bit precision is large enough to hold a maximum value of the one or more lengths.

For some embodiments of the second example method, the bit precision is a power of 2 corresponding to a data type.

Some embodiments of the second example method may further include determining the one or more lengths of the one or more substreams.

Some embodiments of the second example method may further include determining a size of sets of substreams, wherein the size of sets of substreams indicates quantity of substreams within the one or more sets of substreams.

For some embodiments of the second example method, the size of sets of substreams indicates at least the number of substreams in a first set of substreams and a second set of substreams.

For some embodiments of the second example method, wherein the bit precision is a first bit precision, and the second example method may further include: determining a second bit precision, wherein the second bit precision indicates quantity of bits used to represent each of a second set of lengths corresponding respectively to the second set of substreams; writing the second bit precision into the multiplexed bitstream; writing the second set of lengths into the multiplexed bitstream according to the determined second bit precision; and parsing the second set of substreams from the input bitstream, according to the second set of lengths corresponding respectively to the second set of substreams, wherein the first bit precision is different than the second bit precision.

For some embodiments of the second example method, wherein the one or more substreams include three or more sets of substreams, wherein the one or more lengths include three or more sets of lengths, wherein each of the three or more sets of substreams correspond respectively to the three or more sets of lengths, wherein each of the three or more sets of lengths correspond respectively to a bit precision, and wherein each of the respective bit precisions indicates quantity of bits used to represent each of the lengths of the corresponding set of lengths.

An example apparatus in accordance with some embodiments may include: a processor; and a memory storing instructions operative, when executed by the processor, to cause the apparatus to: determine a bit precision, wherein the bit precision indicates quantity of bits used to represent each of one or more lengths corresponding respectively to the one or more substreams; write number of substreams into a multiplexed bitstream; wherein the number of substreams indicates quantity of the one or more substreams; write the bit precision into the multiplexed bitstream; write the one or more lengths of the one or more substreams into the multiplexed bitstream, according to the determined bit precision; and write the one or more substreams into the multiplexed bitstream.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a bitmap showing an example bitstream arrangement for a TMAPv1 multiplexing method according to some embodiments.

FIG. 3 is a process diagram illustrating a first example bitstream multiplexing method according to some embodiments.

FIG. 4 is a process diagram illustrating a first example bitstream demultiplexing method according to some embodiments.

FIG. 5 is a bitmap showing a first example bitstream arrangement for a multiplexing method according to some embodiments.

FIG. 6 is a process diagram illustrating a second example bitstream multiplexing method according to some embodiments.

FIG. 7 is a process diagram illustrating a second example bitstream demultiplexing method according to some embodiments.

FIG. 8 is a bitmap showing a second example bitstream arrangement for a multiplexing method according to some embodiments.

FIG. 9 is a flowchart illustrating an example process to demultiplex an input bitstream according to some embodiments.

FIG. 10 is a flowchart illustrating an example process to multiplex one or more substreams according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

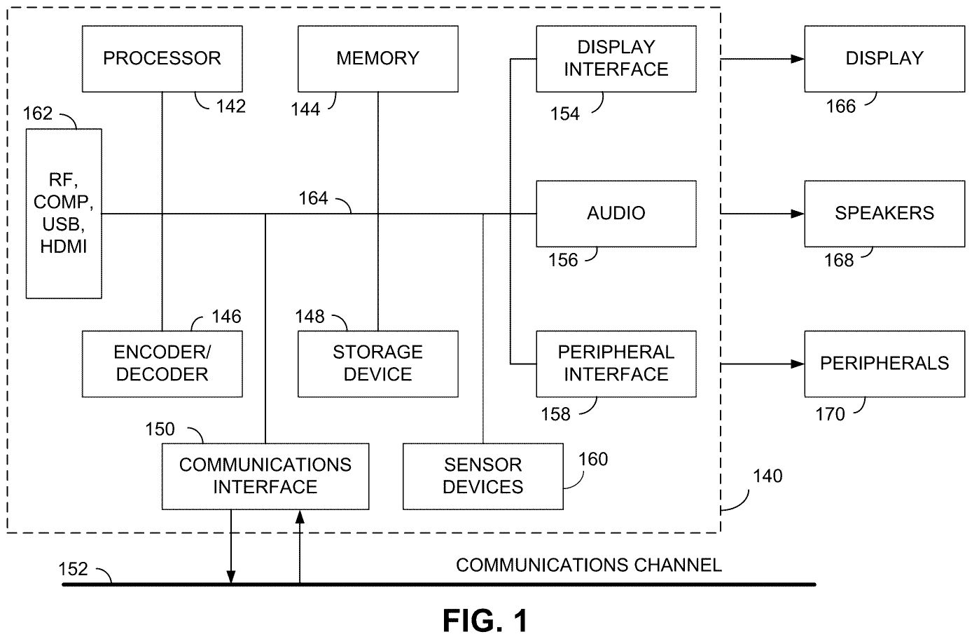

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation, and understanding of point cloud signals.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the application. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors like LiDARs produce (dynamic) point clouds that are used by the perception engine. These point clouds are not intended to be viewed by human eyes, and they are typically sparse, not necessarily colored, and dynamic with a high frequency of capture. They may have other attributes like the reflectance ratio provided by the LiDAR because this attribute may be indicative of the material of the sensed object, and the attribute may be used in making a decision.

Virtual Reality (VR) and immersive worlds have become a hot topic and are foreseen by many as the future of 2D flat video. The viewer is immersed in an environment all around the viewer, while in standard TV, the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data includes discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: geometry coding and attribute coding.

Examples of existing learning-based point cloud geometry compression techniques include deep octree coding and end-to-end feature-based geometry coding. With deep octree coding, neural network-based models are utilized to estimate the occupancy probabilities. Such estimated probabilities are then used to help the arithmetic coder to encode or decode a binary flag indicating whether a child octree voxel is occupied or empty.

A typical learning-based point cloud compression system performs coding hierarchically in a coarse-to-fine manner, starting with the first level of the octree then coding all the way down to the leaves. The coding at each octree level involves one or more substreams. Thus, benefit may be gained from having an efficient way to multiplex these substreams, especially for point clouds with smaller bit depths in which the bitrates are relatively small. The present application provides an efficient way of multiplexing substreams into an overall bitstream.

This application presents a method to multiplex substreams generated in learning-based point cloud compression. In learning-based point cloud compression, the substreams for the first few octree levels are usually very small, while the substreams for the last few octree levels may be large. Using this observation, the present application uses a multiplexing approach that takes into account the range of the lengths of the substreams. This application reduces overhead, especially for point clouds with small bit-depths. Additionally, this application may also be applied to multiplex protection bitstreams for reproducible learning-based point cloud compression.

In learning-based point cloud compression for either geometry coding or attribute coding, the encoding of each octree level involves one or multiple substreams (or data streams). For example, the MPEG AI-PCC TMAPv1 codec has a lossless coding stage and a lossy coding stage for the geometry coding. TMAP v1 for Al-Based Point Cloud Coding, MPEG WG07, w24853 (January 2025) (“MPEG AI-PCC TMAPv1”).

For an example intra coding configuration, lossless encoding of each octree level generates 9 substreams (8 substreams for voxel occupancies and 1 substream for the same-level feature), while lossy encoding of each octree level generates 1 substream for the same-level feature. For inter coding, lossless encoding of each octree level generates 10 substreams (8 substreams for voxel occupancies, 1 substream for the same-level feature, and 1 substream for the motion feature), while the lossy encoding of each octree level generates 2 substreams (1 substream for the same-level feature and 1 substream for the motion feature).

For 10-bit point cloud coding in intra mode, typically either 7 or 8 octree levels are coded in a lossless manner. When 7 levels are coded in a lossless manner and the other 3 levels in a lossy manner, there are 66 substreams ((7*9)+3) in TMAPv1. When 8 levels are coded in a lossless manner and the other 2 levels in a lossy manner, there are 74 substreams ((8*9)+2) in TMAPv1.

Given the necessity to code the substreams, TMAPv1 multiplexes the substreams into one overall bitstream. For example, assume there are n substreams generated when encoding a point cloud, and assume that the lengths of the substreams are l₁, l₂, . . . , lₙ, respectively. TMAPv1 assumes that all of the substreams have a length less than 2\hat{ }32.

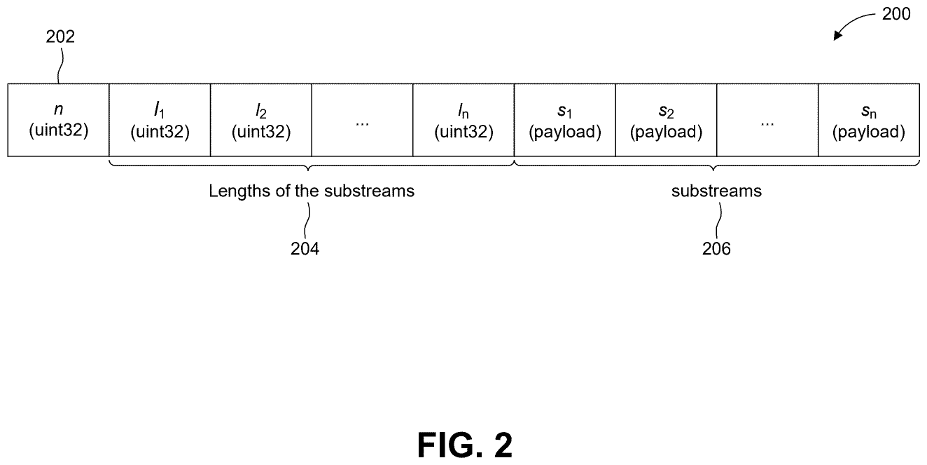

FIG. 2 is a bitmap showing an example bitstream arrangement for a TMAPv1 multiplexing method according to some embodiments.

First, the encoder writes the number of substreams, n, 202 into the bitstream, in which n is represented with a 32-bit unsigned integer (uint32 data type).

Secondly, the encoder writes the n lengths (denoted as l₁, l₂, . . . , lₙ) 204 into the bitstream, in which all of the lengths are represented with a 32-bit unsigned integer (uint32 data type).

Thirdly, the n substreams (denoted as s₁, s₂, . . . , sₙ) 206 are written to the bitstream sequentially. FIG. 2 illustrates how to multiplex the substreams.

To demultiplex the bitstream on the decoder side, the decoder first decodes the number n, followed by the lengths, l₁, l₂, . . . , lₙ, of the substreams. The remaining bits may be parsed into n substreams according to the lengths, l₁, l₂, . . . , lₙ.

A problem with this method is that the lengths of the substreams are usually very small for the first few levels but large for the last few levels. Therefore, always representing the lengths with a fixed data type (uint32) is not efficient. In fact, an 8-bit unsigned integer (uint8 data type) may be sufficient for representing the lengths of the substreams for the first few octree levels.

This observation about the length of the substreams provides inspiration for how to represent the lengths l₁, l₂, . . . , lₙ. To reduce the overhead of representing the lengths l₁, l₂, . . . , lₙ, their range may be checked and the minimum bit precision that is sufficient to represent the lengths may be selected. The selected bit precision may then be used to represent these lengths in the bitstream.

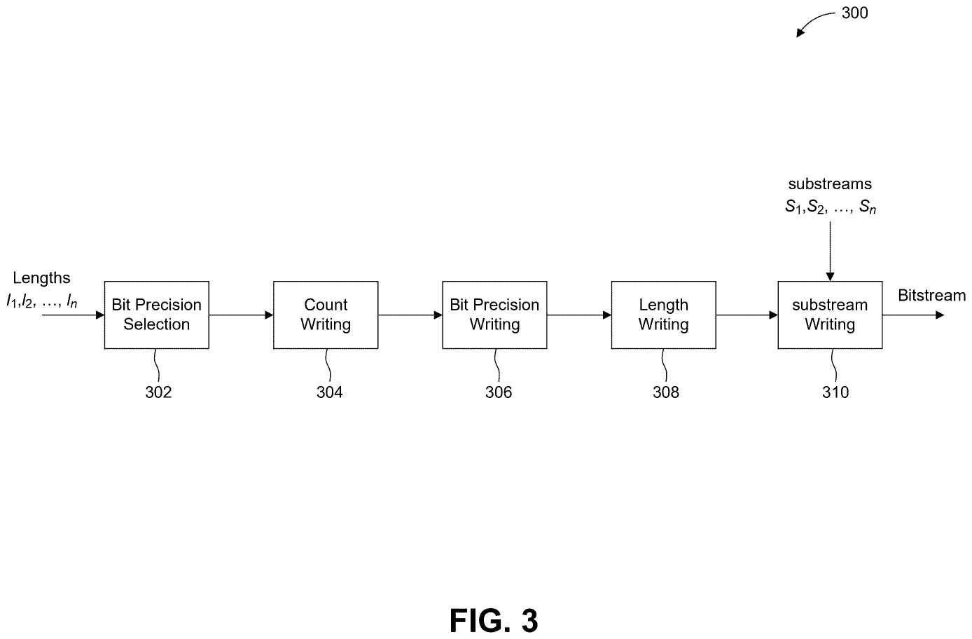

FIG. 3 is a process diagram illustrating a first example bitstream multiplexing method according to some embodiments. FIG. 3 shows a method 300 to multiplex substreams s₁, s₂, . . . , sₙ on the encoder side. The bit precisions used to represent the respective lengths l₁, l₂, . . . , lₙ are adaptively selected by the bit precision selection block 302.

In some embodiments, the bit precision selection block 302 picks the appropriate bit precision to represent the lengths l₁, l₂, . . . , lₙ according to the maximum length in l₁, l₂, . . . , lₙ. Suppose that the maximum length lₘₐₓ=max (l₁, l₂, . . . , lₙ). If lₘₐₓ<256, then the bit precision selection block 302 outputs 8 (representing uint8). Otherwise, if lₘₐₓ<2\hat{ }16, then the bit precision selection block 302 outputs 16 (representing uint16). Otherwise, if lₘₐₓ<2\hat{ }32, then the bit precision selection block 302 outputs 32 (representing uint32). Otherwise, if lₘₐₓ<2\hat{ }64, then the bit precision selection block 302 outputs 64 (representing uint64). For some embodiments, lₘₐₓ≥2\hat{ }64 is not supported.

The count writing block 304 writes the number of substreams n into the bitstream. The bit precision writing block 306 writes the output of the bit precision selection block 302 into the bitstream. This number indicates the number of bits used to represent the lengths. The length writing block 308 writes the lengths l₁, l₂, . . . , lₙ into the bitstream using the selected datatype. The substream writing block 310 writes the substreams s₁, s₂, . . . , sₙ sequentially and outputs the multiplexed bitstream.

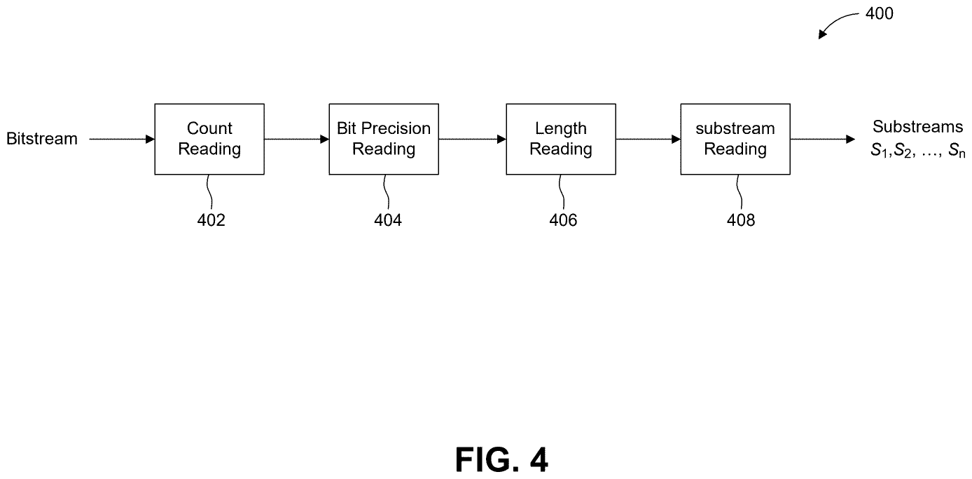

FIG. 4 is a process diagram illustrating a first example bitstream demultiplexing method according to some embodiments. For the example method 400 for demultiplexing of the bitstream on the decoder side (FIG. 4), the count reading block 402 reads the number of sub-bitstreams n. Then, the bit precision reading block 404 reads the bit precision, which represents the number of bits being used to represent the lengths of the substreams. Next, the lengths, l₁, l₂, . . . , lₙ are decoded by the length reading block 406 based on the bit precision that is parsed. The substreams are parsed from the bitstream by the substream reading block 408 according to the lengths l₁, l₂, . . . , lₙ.

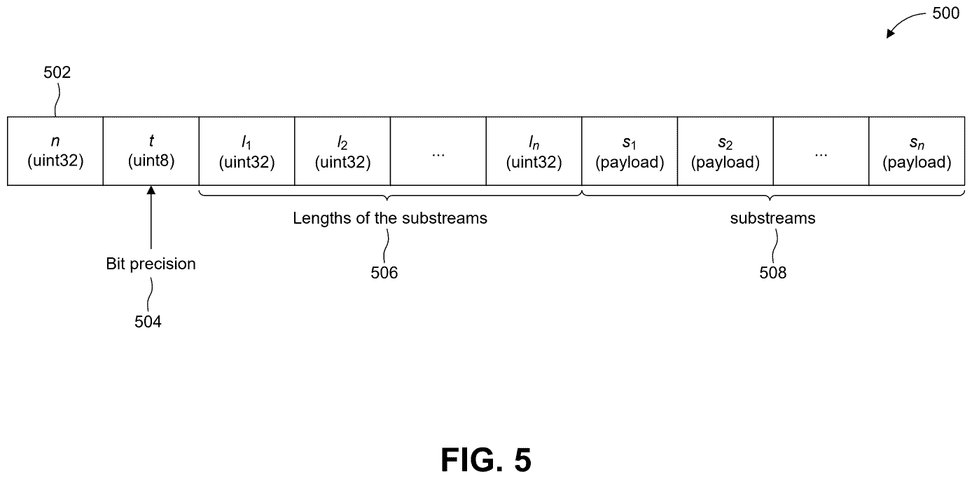

FIG. 5 is a bitmap showing a first example bitstream arrangement for a multiplexing method according to some embodiments. FIG. 5 shows an example bitstream organization 500 for a bitstream multiplexing method. An additional bit precision 504 is used to indicate the number of bits used to represent each of the lengths. This structure achieves a more compact multiplexing of the substreams.

The encoder writes the number of substreams, n, 502 into the bitstream, in which n is represented with a 32-bit unsigned integer (uint32 data type). The encoder then writes the bit precision, t, 504, into the bitstream, in which t is represented with an 8-bit unsigned integer (uint8 data type). The encoder writes the n lengths (denoted as l₁, l₂, . . . , lₙ) 506 into the bitstream, in which all of the lengths are represented with a 32-bit unsigned integer (uint32 data type). The n substreams (denoted as s₁, s₂, . . . , sₙ) 508 are written to the bitstream sequentially.

To demultiplex the bitstream on the decoder side, the decoder first decodes the number n, followed by the bit precision t indicating the bit precision to be used to represent the lengths. Next, the decoder decodes the lengths, l₁, l₂, . . . , lₙ, of the substreams according to the bit precision t. The remaining bits may be parsed into n substreams according to the lengths, l₁, l₂, . . . , lₙ.

For some embodiments, additional flexibility is introduced by partitioning the substreams into several groups and using a dedicated bit precision field to represent the number of bits for the lengths of each group. Each group is assumed to have k substreams (except for the last group if n is not an integer multiple of k). A typical choice of k may be 9 for the case of TMAPv1, in which every 9 substreams contain the octree level information.

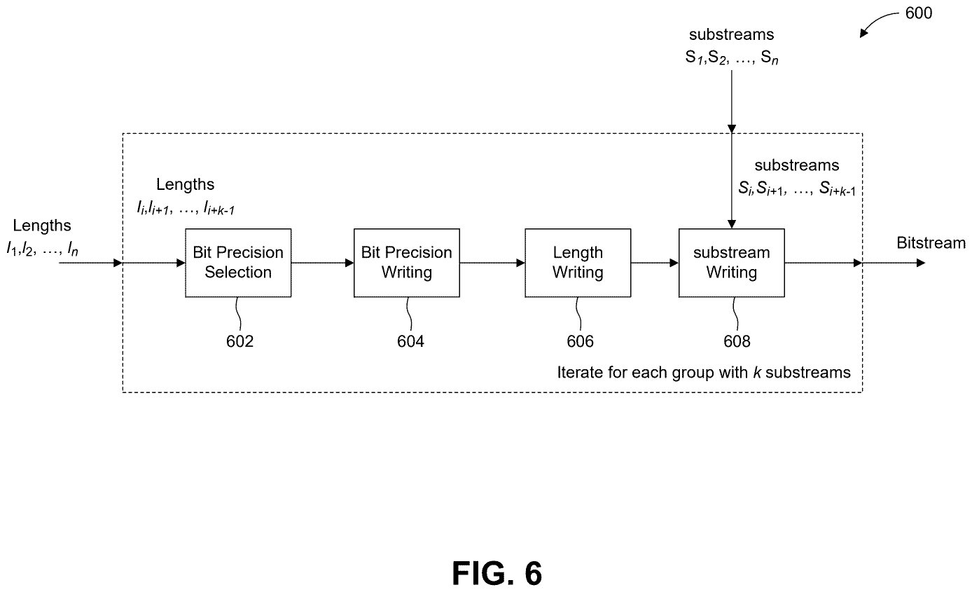

FIG. 6 is a process diagram illustrating a second example bitstream multiplexing method according to some embodiments. FIG. 6 shows an example multiplexing method 600. For some embodiments, the number of substreams n is written into the bitstream, followed by writing the number of bitstreams in each group, k, into the bitstream. This preparation step is not shown in FIG. 6 for simplicity reasons.

For each group of substreams, sᵢ, sᵢ₊₁, . . . , sᵢ₊ₖ₋₁, and their corresponding lengths, lᵢ, lᵢ₊₁, . . . , lᵢ₊ₖ₋₁, a similar set of operations are performed. A bit precision selection block 602 selects the bit precision according to lengths lᵢ, lᵢ₊₁, . . . , lᵢ₊ₖ₋₁. A bit precision writing block 604 writes the bit precision into the bitstream for the current group. A length writing block 606 writes the lengths lᵢ, lᵢ₊₁, . . . , lᵢ₊ₖ₋₁, for the selected bit precision. A substream writing block 608 writes the substreams sᵢ, sᵢ₊₁, . . . , sᵢ₊ₖ₋₁ to the bitstream. These four steps (or blocks 602, 604, 606, 608) are invoked for each group of substreams, leading to the final, multiplexed bitstream.

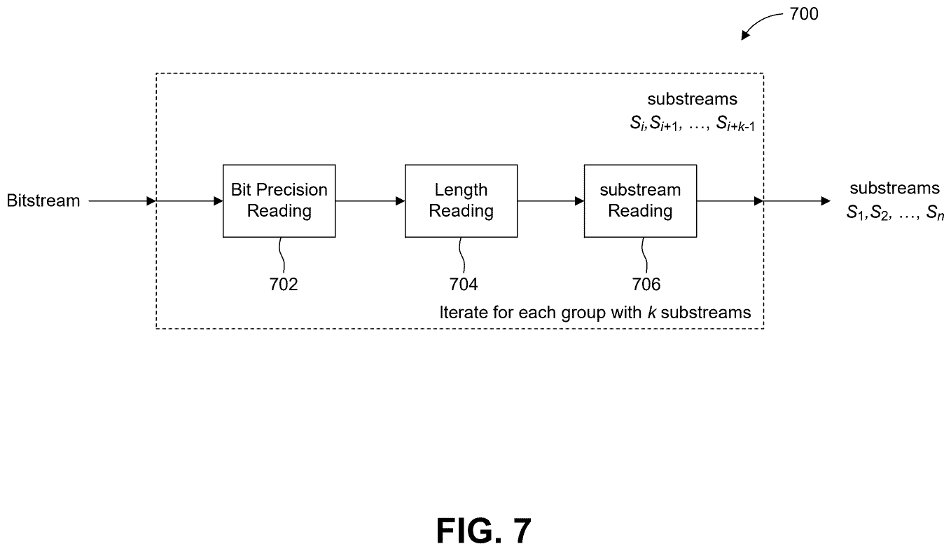

FIG. 7 is a process diagram illustrating a second example bitstream demultiplexing method according to some embodiments. FIG. 7 shows an example bitstream demultiplexing method 700. For some embodiments, the number of substreams, n, are read from the bitstream, and the number of bitstreams in each group, k, are read from the bitstream. This preparation step is not shown in FIG. 7 for simplicity reasons.

To parse each group of substreams sᵢ, sᵢ₊₁, . . . , sᵢ₊ₖ₋₁, a similar set of operations are performed. A bit precision reading block 702 reads the bit precision of the current group. A length reading block 704 reads the lengths lᵢ, lᵢ₊₁, . . . , lᵢ₊ₖ₋₁, according to the obtained bit precision/A substream reading block 706 reads the substreams sᵢ, sᵢ₊₁, . . . , sᵢ₊ₖ₋₁. These three steps (or blocks 702, 704, 706) are invoked for each group of substreams, leading to the final, demultiplexed substreams.

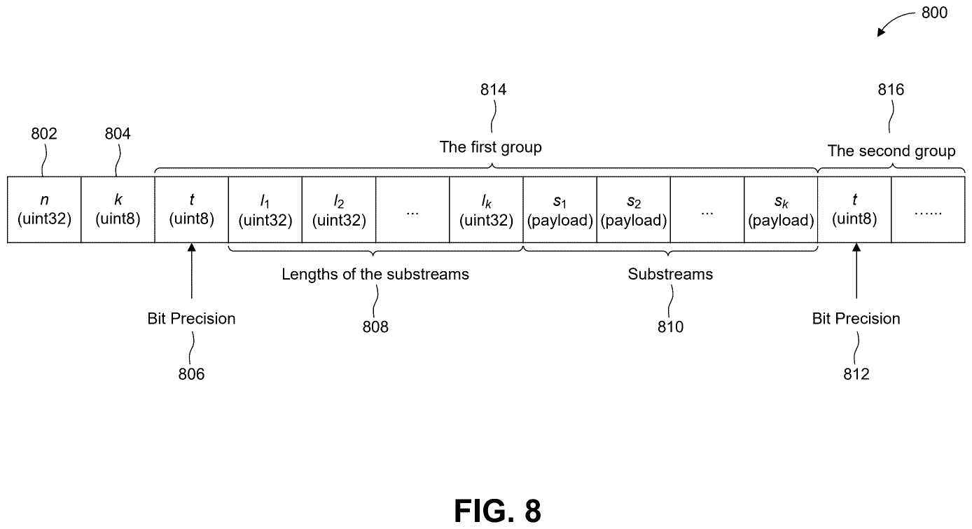

FIG. 8 is a bitmap showing a second example bitstream arrangement for a multiplexing method according to some embodiments. FIG. 8 shows an example bitstream organization 800 for a bitstream multiplexing method. A bit precision field 806 is dedicated for each group of substreams to make the coding of the lengths more effective.

For some embodiments, after putting n (802) and k (804) in the bitstream, the type indicator 806 of the first group 814 is added to the bitstream. The type indicator 806 is followed by the lengths of the substreams 808 and the substreams 810 of the first group 814. Next, the type indicator 812 of the second group 816, followed by the lengths of the substreams and the substreams of the second group 816. Thirdly (if applicable), the type indicator of the third group, followed by the lengths of the substreams and the substreams of the third group, and so on. For the last group, the type indicator of the last group is added to the bitstream, followed by the lengths of the substreams and the substreams of the last group.

For some embodiments, the headers of each group are written to the bitstream back-to-back all together. A header for a group includes its bit precision and the lengths of its substreams. For some embodiments, after all the type indicators and the lengths are coded in the multiplexed bitstream, all n substreams are appended sequentially together in the multiplexed bitstream (not shown in FIG. 8). For example, in some embodiments, the bitmap may be: (n, k, t, l₁, l₂, . . . , lₖ, t, l₁, l₂, . . . , lₖ, . . . , t, l₁, l₂, . . . , lₖ, s₁, s₂, . . . , sₙ), in which t, l₁, l₂, . . . , lₖ is the header for a group.

In some embodiments, the encoder/decoder may signal/decode a syntax element (e.g., substream_length_size_precision_minus1), which indicates the precision with which to define the data length of each substream within a coded slice data. The syntax element may be coded using exp coulomb codes to save bits. The precision of the data of each octree level is as shown in Eq. 1:

$$Bit Precision of Substream Data Length = {2}^{( substream \_ length \_ size \_ precision \_ minus 1 + 1 )} \qquad ( 1 )$$

As seen in Eq. 2, the bit precision is a multiple of 2.

The encoder/decoder may signal/decode a syntax element (e.g., substream_length_size) that indicates the bytedata length of the substream in the coded slice unit. The bytedata length information is used to write/parse the coded data for each substream within a coded slice. The descriptor used for substream_length_size is u(v) in which v is determined by the bit precision of the data length signaled in syntax element substream_length_size_precision_minus1.

In some embodiments, the bit precision for the length of the coded data for each octree level may be implicitly determined by a global variable set within a parameter set, such as a sequence parameter set or frame parameter set. Such a parameter may be called global_substream_len_size_precision_minus1. The global variable may indicate the precision of the length of the substream coded in the slice data unit. The length of the coded substream is as shown in Eq. 2:

$$Bit Precision of Substream Data Length = {2}^{( global \_ substream \_ len \_ size \_ precision \_ minus 1 + 1 )} \qquad ( 2 )$$

This approach may lead to unnecessary use of higher precisions of Bytestream length in which some substreams are coded with variable coded data, which may lead to wasted memory resources.

For some embodiments, the encoder/decoder may signal/decode a syntax element (e.g., substream_length_size) to indicate the bytedata length of the coded substream within a coded slice data unit. The bytedata length information is used to write/parse the coded data for each substream within a coded slice. The descriptor used for substream_length_size is u(v), in which v is determined by the derived bit precision of the data length as shown in Eq. 2.

TABLE 1

| Code Line | Descriptor |
|---|---|
| . . . | |
| substream_precision_size_minus1_present_flag | u(1) |
| for (substreamIdx=0; substreamIdx <= n; subStreamIdx++) { | |
| if (substream_precision_size_minus1_present_flag) { | |
| substream_length_size_precision_minus1[substreamIdx] | ue(v) |
| substream_length_size[substreamIdx] | u(v) |
| } | |
| } | |
| . . . | |

The semantics of the syntax elements of Table 1 are described below.

Setting the flag “substream_precision_size_minus1_present_flag” equal to 1 indicates the presence of precision size for each substream in the bitstream. Setting the flag “substream_level_precision_size_minus1_present_flag” equal to 0 indicates that the bit precision of the data length is derived implicitly using the frame parameter set syntax structure.

The array “substream_length_size_precision_minus1[ ]” indicates the precision used to define the length of the data for each substream corresponding to index substreamIdx.

The array “substream_length_size [ ]” indicates the data length of the coded substream for each substream corresponding to index substreamIdx.

The syntax elements described in the table above may be indicated within a slice header or a frame parameter set within a bitstream. A slice data unit in the MPEG AI-PCC TMAPv1 document contains all the coded data for the entire slice (for both lossless and lossy). If the syntax elements are indicated in the slice header, then such a methodology provides the flexibility to change the precision and data length size for each substream within slice. However, this methodology may lead to an increased management of bit precision and data length for each slice. Alternatively, the syntax elements described in the table above may be signaled/decoded within/from the frame parameter set within the bitstream to provide information related to all slice data units within a frame. The syntax elements within the frame parameter set may remain applicable for coded slices in a frame or a group of frames, thereby restricting the control over flexibility of bit precision and data length for octree levels in each coded slice.

### Application for Learning-Based Reproducible Compression

Some embodiments multiplex the substreams generated by an octree-based coder (lossless) and a feature-based coder (lossy). Some embodiments multiplex the protection bitstreams generated by the '370 application. For some embodiments, each of the occupancy substream generated in octree-based coding may be protected by a protection bitstream to protect the probability computation. Moreover, each of the feature substreams generated in feature-based coding may be protected by a protection bitstream to protect the hyperprior synthesis process.

All of these protection bitstreams may be multiplexed into an overall protection bitstream for the point cloud frame. The motivation for such a multiplexing is that the protection bitstreams for the first few octree levels are usually very small. Therefore, applying this multiplexing method may reduce overhead, especially for point clouds with smaller bit-depths.

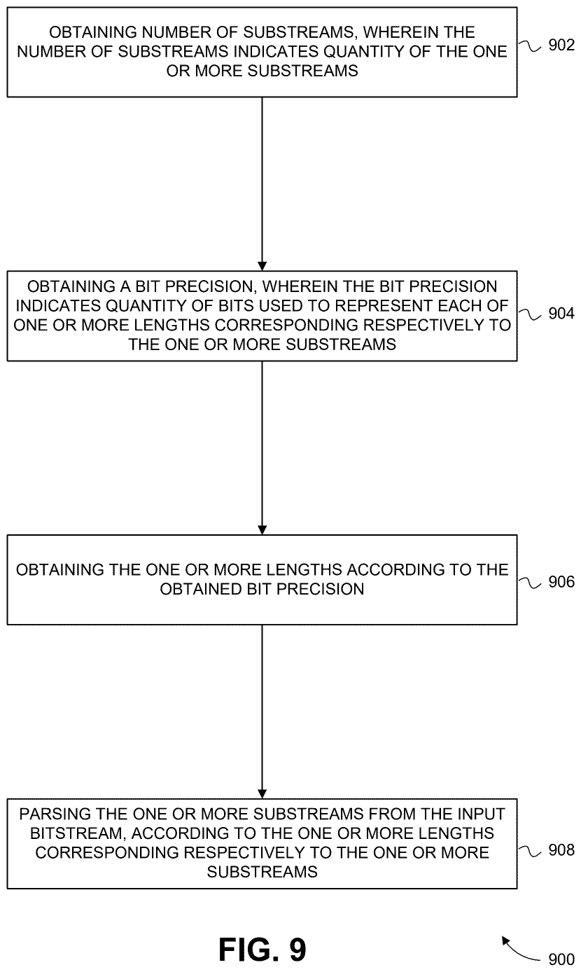

FIG. 9 is a flowchart illustrating an example process to demultiplex an input bitstream according to some embodiments. For some embodiments, an example process 900 may include obtaining 902 number of substreams, wherein the number of substreams indicates quantity of the one or more substreams. For some embodiments, the example process 900 may further include obtaining 904 a bit precision, wherein the bit precision indicates quantity of bits used to represent each of one or more lengths corresponding respectively to the one or more substreams. For some embodiments, the example process 900 may further include obtaining 906 the one or more lengths according to the obtained bit precision. For some embodiments, the example process 900 may further include parsing 908 the one or more substreams from the input bitstream, according to the one or more lengths corresponding respectively to the one or more substreams.

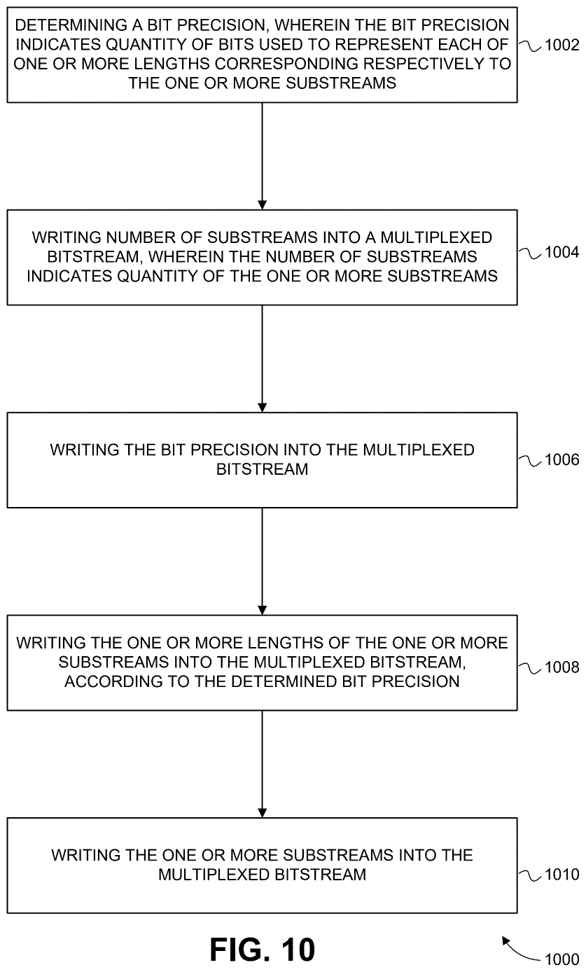

FIG. 10 is a flowchart illustrating an example process to multiplex one or more substreams according to some embodiments. For some embodiments, an example process 1000 may include determining 1002 a bit precision, wherein the bit precision indicates quantity of bits used to represent each of one or more lengths corresponding respectively to the one or more substreams. For some embodiments, the example process 1000 may further include writing 1004 number of substreams into a multiplexed bitstream, wherein the number of substreams indicates quantity of the one or more substreams. For some embodiments, the example process 1000 may further include writing 1006 the bit precision into the multiplexed bitstream. For some embodiments, the example process 1000 may further include writing 1008 the one or more lengths of the one or more substreams into the multiplexed bitstream, according to the determined bit precision. For some embodiments, the example process 1000 may further include writing 1010 the one or more substreams into the multiplexed bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining number of substreams, wherein the number of substreams indicates quantity of one or more substreams; obtaining a bit precision, wherein the bit precision indicates quantity of bits used to represent each of one or more lengths corresponding respectively to the one or more substreams; obtaining the one or more lengths according to the obtained bit precision; and parsing the one or more substreams from an input bitstream, according to the one or more lengths corresponding respectively to the one or more substreams.

Some embodiments of the first example method may further include obtaining the input bitstream.

For some embodiments of the first example method, the bit precision is large enough to hold a maximum value of the one or more lengths.

For some embodiments of the first example method, the bit precision is a power of 2 corresponding to a data type.

For some embodiments of the first example method, the bit precision is selected from the group consisting of 8, 16, 32, and 64.

Some embodiments of the first example method may further include obtaining a size of sets of substreams, wherein the size of sets of substreams indicates quantity of substreams within the one or more sets of substreams.

For some embodiments of the first example method, the size of sets of substreams indicates at least the number of substreams in a first set of substreams and a second set of substreams.

For some embodiments of the first example method, the bit precision is a first bit precision, and the first example method may further include: obtaining a second bit precision, wherein the second bit precision indicates quantity of bits used to represent each of a second set of lengths corresponding respectively to the second set of substreams; obtaining the second set of lengths according to the obtained second bit precision; and parsing the second set of substreams from the input bitstream, according to the second set of lengths corresponding respectively to the second set of substreams, wherein the first bit precision is different than the second bit precision.

For some embodiments of the first example method, wherein the one or more substreams include three or more sets of substreams, wherein the one or more lengths include three or more sets of lengths, wherein each of the three or more sets of substreams correspond respectively to the three or more sets of lengths, wherein each of the three or more sets of lengths correspond respectively to a bit precision, and wherein each of the respective bit precisions indicates quantity of bits used to represent each of the lengths of the corresponding set of lengths.

Some embodiments of the first example method may further include rendering the one or more substreams on a display device.

A second example method in accordance with some embodiments may include: determining a bit precision, wherein the bit precision indicates quantity of bits used to represent each of one or more lengths corresponding respectively to one or more substreams; writing number of substreams into a multiplexed bitstream, wherein the number of substreams indicates quantity of the one or more substreams; writing the bit precision into the multiplexed bitstream; writing the one or more lengths of the one or more substreams into the multiplexed bitstream, according to the determined bit precision; and writing the one or more substreams into the multiplexed bitstream.

For some embodiments of the second example method, writing the one or more substreams into the multiplexed bitstream writes the one or more substreams sequentially into the multiplexed bitstream.

For some embodiments of the second example method, the bit precision is large enough to hold a maximum value of the one or more lengths.

For some embodiments of the second example method, the bit precision is a power of 2 corresponding to a data type.

Some embodiments of the second example method may further include determining the one or more lengths of the one or more substreams.

Some embodiments of the second example method may further include determining a size of sets of substreams, wherein the size of sets of substreams indicates quantity of substreams within the one or more sets of substreams.

For some embodiments of the second example method, the size of sets of substreams indicates at least the number of substreams in a first set of substreams and a second set of substreams.

For some embodiments of the second example method, wherein the bit precision is a first bit precision, and the second example method may further include: determining a second bit precision, wherein the second bit precision indicates quantity of bits used to represent each of a second set of lengths corresponding respectively to the second set of substreams; writing the second bit precision into the multiplexed bitstream; writing the second set of lengths into the multiplexed bitstream according to the determined second bit precision; and parsing the second set of substreams from the input bitstream, according to the second set of lengths corresponding respectively to the second set of substreams, wherein the first bit precision is different than the second bit precision.

For some embodiments of the second example method, wherein the one or more substreams include three or more sets of substreams, wherein the one or more lengths include three or more sets of lengths, wherein each of the three or more sets of substreams correspond respectively to the three or more sets of lengths, wherein each of the three or more sets of lengths correspond respectively to a bit precision, and wherein each of the respective bit precisions indicates quantity of bits used to represent each of the lengths of the corresponding set of lengths.

An example apparatus in accordance with some embodiments may include: a processor; and a memory storing instructions operative, when executed by the processor, to cause the apparatus to: determine a bit precision, wherein the bit precision indicates quantity of bits used to represent each of one or more lengths corresponding respectively to the one or more substreams; write number of substreams into a multiplexed bitstream; wherein the number of substreams indicates quantity of the one or more substreams; write the bit precision into the multiplexed bitstream; write the one or more lengths of the one or more substreams into the multiplexed bitstream, according to the determined bit precision; and write the one or more substreams into the multiplexed bitstream.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “l”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method to demultiplex an input bitstream into one or more substreams representing information of one or more octree levels from a point cloud, comprising:
obtaining number of substreams,
wherein the number of substreams indicates quantity of the one or more substreams;
obtaining a bit precision,
wherein the bit precision indicates quantity of bits used to represent each of one or more lengths corresponding respectively to the one or more substreams;
obtaining the one or more lengths according to the obtained bit precision; and
parsing the one or more substreams from the input bitstream, according to the one or more lengths corresponding respectively to the one or more substreams.

2. The method of claim 1, further comprising obtaining the input bitstream.

3. The method of claim 1, wherein the bit precision is large enough to hold a maximum value of the one or more lengths.

4. The method of claim 1, wherein the bit precision is a power of 2 corresponding to a data type.

5. The method of claim 4, wherein the bit precision is selected from the group consisting of 8, 16, 32, and 64.

6. The method of claim 1, further comprising:
obtaining a size of sets of substreams,
wherein the size of sets of substreams indicates quantity of substreams within the one or more sets of substreams.

7. The method of claim 6, wherein the size of sets of substreams indicates at least the number of substreams in a first set of substreams and a second set of substreams.

8. The method of claim 7,
wherein the bit precision is a first bit precision, and
further comprising:
obtaining a second bit precision,
wherein the second bit precision indicates quantity of bits used to represent each of a second set of lengths corresponding respectively to the second set of substreams;
obtaining the second set of lengths according to the obtained second bit precision; and
parsing the second set of substreams from the input bitstream, according to the second set of lengths corresponding respectively to the second set of substreams,
wherein the first bit precision is different than the second bit precision.

9. The method of claim 6,
wherein the one or more substreams comprise three or more sets of substreams,
wherein the one or more lengths comprise three or more sets of lengths,
wherein each of the three or more sets of substreams correspond respectively to the three or more sets of lengths,
wherein each of the three or more sets of lengths correspond respectively to a bit precision, and
wherein each of the respective bit precisions indicates quantity of bits used to represent each of the lengths of the corresponding set of lengths.

10. The method of claim 1, further comprising rendering the one or more substreams on a display device.

11. A method to multiplex one or more substreams representing information of one or more octree levels from a point cloud, comprising:
determining a bit precision,
wherein the bit precision indicates quantity of bits used to represent each of one or more lengths corresponding respectively to the one or more substreams;
writing number of substreams into a multiplexed bitstream,
wherein the number of substreams indicates quantity of the one or more substreams;
writing the bit precision into the multiplexed bitstream;
writing the one or more lengths of the one or more substreams into the multiplexed bitstream, according to the determined bit precision; and
writing the one or more substreams into the multiplexed bitstream.

12. The method of claim 11, wherein writing the one or more substreams into the multiplexed bitstream writes the one or more substreams sequentially into the multiplexed bitstream.

13. The method of claim 11, wherein the bit precision is large enough to hold a maximum value of the one or more lengths.

14. The method of claim 11, wherein the bit precision is a power of 2 corresponding to a data type.

15. The method of claim 11, further comprising determining the one or more lengths of the one or more substreams.

16. The method of claim 11, further comprising:
determining a size of sets of substreams,
wherein the size of sets of substreams indicates quantity of substreams within the one or more sets of substreams.

17. The method of claim 16, wherein the size of sets of substreams indicates at least the number of substreams in a first set of substreams and a second set of substreams.

18. The method of claim 17,
wherein the bit precision is a first bit precision, and
further comprising:
determining a second bit precision,
wherein the second bit precision indicates quantity of bits used to represent each of a second set of lengths corresponding respectively to the second set of substreams;
writing the second bit precision into the multiplexed bitstream;
writing the second set of lengths into the multiplexed bitstream according to the determined second bit precision; and
parsing the second set of substreams from the input bitstream, according to the second set of lengths corresponding respectively to the second set of substreams,
wherein the first bit precision is different than the second bit precision.

19. The method of claim 16,
wherein the one or more substreams comprise three or more sets of substreams,
wherein the one or more lengths comprise three or more sets of lengths,
wherein each of the three or more sets of substreams correspond respectively to the three or more sets of lengths,
wherein each of the three or more sets of lengths correspond respectively to a bit precision, and
wherein each of the respective bit precisions indicates quantity of bits used to represent each of the lengths of the corresponding set of lengths.

20. An apparatus comprising:
a processor; and
a memory storing instructions operative, when executed by the processor, to cause the apparatus to:
determine a bit precision,
wherein the bit precision indicates quantity of bits used to represent each of one or more lengths corresponding respectively to the one or more substreams;
write number of substreams into a multiplexed bitstream;
wherein the number of substreams indicates quantity of the one or more substreams;
write the bit precision into the multiplexed bitstream;
write the one or more lengths of the one or more substreams into the multiplexed bitstream, according to the determined bit precision; and
write the one or more substreams into the multiplexed bitstream.
